(19) United States
(12) Patent Application Publication
(10) Pub. No.: US 2025/0123828 A1
(43) Pub. Date: Apr. 17, 2025

(54) LOCAL AGENT-PROVIDED CONFIGURATION ASSISTANCE FOR REMOTELY MANAGED OPERATING SYSTEM INSTALLATIONS

(71) Applicant: Hewlett Packard Enterprise Development LP, Spring, TX (US)

(72) Inventors: Sandeep Bangalore Harshavardhana, Bangalore (IN); Chethan Konasagara Thippeswamy, Bangalore (IN); Dominic Fernandes, San Jose, CA (US)

(21) Appl. No.: 18/430,089

(22) Filed: Feb. 1, 2024

(30) Foreign Application Priority Data
Oct. 17, 2023 (IN) 202341070615

(51) Int. Cl. G06F 8/61

(52) U.S. Cl. CPC G06F 8/63

(57) ABSTRACT

A process includes, responsive to a computer platform being controlled by an operating system installation service that is remote with respect to the computer platform, retrieving, by the computer platform, an agent image, and booting, by the computer platform, to the agent image to launch a local agent that is executed on the computer platform. The process includes assisting, by the local agent, an installation of an operating system on the computer platform. The assisting includes accessing, by the local agent, an operating system installation image and generating an answer file to configure installation of the operating system using the operating system installation image.

### BACKGROUND

New servers may be continually be added to a data center for such purposes as replacing failed servers, upgrading servers and expanding the data center's compute compacity. When a new server is added, various tasks may be performed to configure, or set up, the server, including tasks related to installing an operating system on the server. A server may execute an operating system for purposes of managing the server's hardware and software resources, including managing the execution of applications and managing access to peripherals of the server.

### BRIEF DESCRIPTION OF THE DRAWINGS

FIG. 1 is a block diagram of a computer system having managed nodes and a remote node management system that provides a service to manage the installation of operating systems on the nodes according to an example implementation.

FIG. 2 is a sequence flow diagram illustrating communications among components to install an operating system on a managed node using a remote node management service and a local operating system installation assistance agent on the node according to an example implementation.

FIG. 3 is a flow diagram depicting a process that is performed by a local operating system installation assistance agent to retrieve operating system installation files according to an example implementation.

FIG. 4 is a flow diagram depicting a process that uses a local agent to assist an operating system installation that is managed by a remote operating system installation service according to an example implementation.

FIG. 5 is an illustration of machine-readable instructions that, when executed by one or multiple machines associated with a management service, cause the machine(s) to install an operating system on a remote server using an agent that executes on the server to generate an answer file to configure the installation according to an example implementation.

FIG. 6 is a block diagram of a computer platform that includes a management controller that, responsive to requests from a remote operating system installation service, retrieves an agent image and causes the computer platform to boot to the agent image to launch an agent to assist in an operating system installation, according to an example implementation.

### DETAILED DESCRIPTION

One of the first tasks to set up a new server that arrives at a data center is to install an operating system on the server. An information technology (IT) administrator may directly oversee the operating system installation. For example, in one approach, an IT administrator may first connect input/output (I/O) devices (e.g., a physical monitor, keyboard and a mouse) to the server, and then the IT administrator may use the connected I/O devices to communicate with the server to manage the operating system installation. In another approach, an IT administrator may forego the use of connected I/O devices and instead remotely connect to the server through the server's network interface and take advantage of remotely-controlled management capabilities of the server to manage the operating system installation. Such directly-managed approaches to overseeing operating system installation may not be viable for a large-scale computer system that has hundreds to thousands of servers and in which new servers are continually being added.

In another approach, a cloud-based server management service may be used to offload at least some aspects of operating system installation from IT personnel. Even with the use of a cloud-based server management service, however, customizing the operating system installation for a server may be a daunting administrative task. In this manner, an operating system installation on a particular server may be customized by a variety of configuration options (also called “selected configuration options” and “configuration option selections” herein) that are specific to the server. In examples, configuration options may include a time zone, a display language, a user name, user credentials, an administrator name, administrator credentials, a license key, an internet (IP) address, as well as other customization options. An operating system installation process that uses attended operating system installation media prompts a user (e.g., an IT administrator) at different times during the installation to input configuration option selections. An IT administrator attending each operating system installation to select configuration options may be impractical for a large-scale computer system.

Another way to perform operating system customization is to use unattended operating system installation media. An operating system installation process that uses unattended operating system installation media does not prompt for configuration option selections during the installation, but rather, the operating system installation process searches for a specific file, called an answer file (e.g., an eXtended Markup Language (XML) file), which provides the specific configuration options. Although the use of unattended operating system installation media eliminates attendance during the installation, generating an answer file for each installation, may be particularly burdensome. For example, to create an unattended operating system installation image for a WINDOWS operating system, an IT administrator may first install the WINDOWS Assessment and Deployment Kit (ADK) and configures the installed ADK. Next, the IT administrator may use the ADK to create an answer file, and then, the IT administrator may extract an ISO image (the operating system installation media) and place the answer file in the ISO image. As can be appreciated, creating an answer file for a single unattended operating system installation may be a laborious and time-consuming task, much less creating answer files for multiple installations.

In accordance with example implementations, an operating system is installed on a managed node (e.g., a server) using a remote node management service, operating system installation media and a local operating system installation assistance agent that executes on the managed node. In accordance with example implementations, the operating system installation assistance agent prepares the managed node for the installation of the operating system. In an example, the preparation may include the operating system installation assistance agent fetching, or retrieving files, of operating system installation media and storing the files on the managed node. In another example, the preparation may include the operating system installation assistance agent generating an answer file that provides configuration options for the unattended operating system installation process. In another example, the preparation may include the operating system installation assistance agent initiating the execution of a particular executable file of the operating system installation media to begin the operating system installation process.

The operating system installation media may correspond to an image, such as an ISO image. A local system (e.g., a data center) containing a group of managed nodes may locally store operating system installation images that correspond to multiple operating systems in a local repository. Moreover, the local repository may store multiple versions of corresponding operating system installation images that are associated with the same operating system. As can be appreciated, a particular operating system installation image may be used to install the same operating system on multiple managed nodes, with the installation for each managed node being customized by the configuration options that are set forth in the respective answer file.

As a more specific example, in accordance with example implementations, a remote node management service uses or invokes remotely-controlled management functions (called “remote management features” herein) of a managed node to install an operating system on the node. The remote management functions may be provided by a baseboard management controller (BMC) of the managed node. In an example, a remote node management service may communicate with the BMC of a managed node to cause operating system configuration options for the managed node to be stored in a local secure repository (e.g., a firmware repository or “NAND repository”) of the managed node. These locally-stored configuration options may then be accessed by a local operating system installation assistance agent to generate an answer file using the appropriate syntax and semantics for purposes of providing the configuration options to an unattended operating system installation process.

For purposes of installing an operating system on a managed node, a remote node management service may request the BMC of the managed node to retrieve an agent image (e.g., an ISO image), which contains machine-readable instructions that correspond to the agent. In an example, the BMC may retrieve the agent image from a content delivery network and store the retrieved agent image locally on the managed node (e.g., store the agent image in a secure repository of the node). Next, the remote node management service may request the BMC to mount the agent image as virtual media, and then, the remote node management service may request the BMC to set up the managed node to boot one time from the virtual media. With the managed node being set up to boot one time from the virtual media, the remote node management service may then request the BMC to power on the managed node. When the managed node powers on, the managed node boots from the virtual media and therefore, boots from the agent image. Booting from the agent image, in turn, launches the operating system installation assistance agent, which assists in the installation of an operating system on the managed node. The assistance includes generating, by the operating system installation assistance agent, an answer file based on the locally-stored configuration options and initiating the unattended operating system installation process.

Among the potential advantages of the systems and techniques that are described herein, an IT administrator may, with relative ease, set up configuration options for unattended operating system installations for a fleet of managed nodes without undergoing the burdensome tasks of creating answer files for each managed node or adding such answer files to the operating system installation media. Operating system installation assistance agents may be tailored to different operating systems that accommodate the differences in the answer files for the operating systems. Moreover, the systems and techniques that are described herein avoid dedicated operating system installation hardware and tools (e.g., hardware and tools to allow Preboot eXecution environment (PXE)-based installation) and corresponding setup by IT administrators.

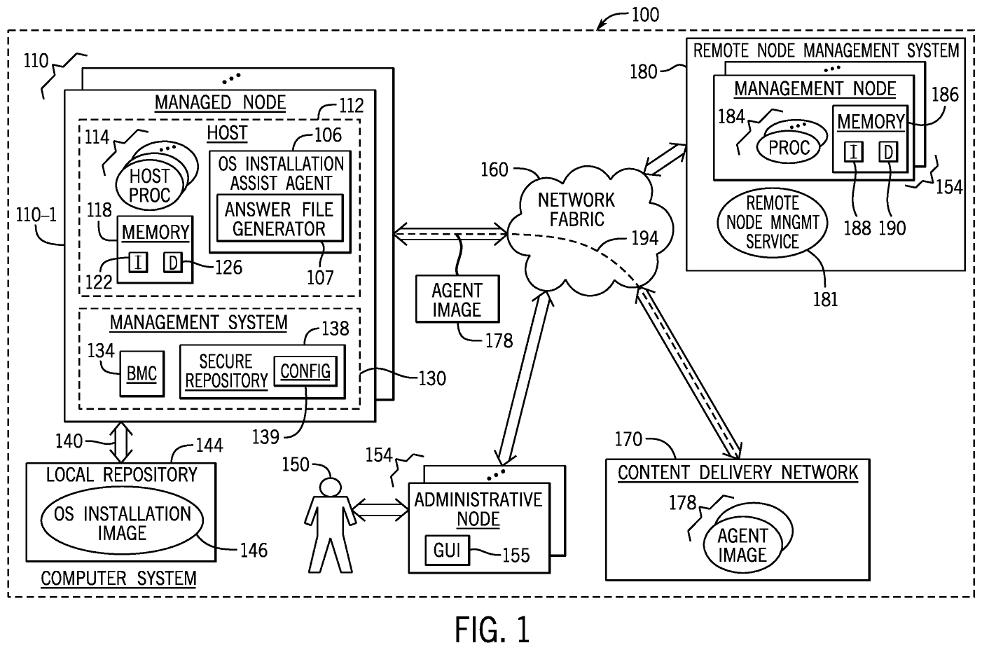

Referring to FIG. 1, as a more specific example, in accordance with some implementations, a computer system 100 includes one or multiple managed nodes 110, which are managed by a remote node management service 181 that is provided by a remote node management system 180. In this context, “remote” and “local” are relative terms, designating whether entities or services are located in the same or different networks. In an example, a local entity, such as a managed node 110, is located in a different network than a remote entity, such the remote node management system 180. In another example, a local entity, such as a managed node 110, is located in a different network than a component that provides a remote service, such as, for example, the remote management service 181.

In an example, multiple managed nodes 110 may be co-located in a data center. In another example, multiple managed nodes 110 may be co-located in an office that is affiliated with a local branch network. In another example, the computer system 100 may include multiple clusters of managed nodes 110 (e.g., clusters located in respective local networks).

In an example, the node management system 180 may be a cloud-based system that is hosted by resources that are located in one or multiple data centers. In an example, the node management system 180 may be distributed across one or multiple geographical locations and/or availability zones. The remote node management system 180 may be separate from a local branch network that contains the managed nodes 110 and may be part of a larger wide area network (WAN), such as the Internet. In an example, the remote node management service 181 may be a subscription-based service (e.g., a Software-as-a-Service (SaaS)).

In the context that is used herein, a “node” refers to a processor-based entity that has an associated set of hardware and software resources. In an example, a managed node 110 may associated with a computer platform. In this context, a “computer platform” is a processor-based electronic device, which has an associated operating system. As examples, a computer platform may be a standalone server; a distributed server; a rack-mounted server module; an edge processing, rack-mounted module; a blade server; a blade enclosure containing one or multiple blade servers; a client; a thin client; a desktop computer; a portable computer; a laptop computer; a notebook computer; a tablet computer; network device; a network switch, a gateway device, a smartphone; a wearable computer; or another processor-based platform.

In an example, a managed node 110 may be an actual, physical computer platform. In an example, a managed node 110 may correspond to an entire bare metal server. In another example, a managed node 110 may be virtual. In an example, a managed node 110 may be an abstraction of hardware and software resources of a corresponding physical computer platform, such as a virtual machine that is hosted on the computer platform. In an example, a particular physical computer platform may host multiple virtual machines that correspond to multiple managed nodes 110. As can be appreciated, the managed nodes 110 may correspond to one or multiple physical computer platforms.

Specific components of an exemplary managed node 110-1 are depicted in FIG. 1 and described herein. Other managed nodes 110 may have similar components, in accordance with example implementation.

As depicted in FIG. 1, the managed node 110-1 is associated with a host 112 and a management system 130. In this context, a “host” refers to a collection of components, such as one or multiple host processors 114 and a system memory 118, which are constructed to host and provide an operating system. In this context, an “operating system” refers to software that manages hardware and software resources (e.g., virtual or physical hardware) of the managed node 110-1 as well as provides services for other software components (e.g., applications) that execute on the managed node 110. In examples, the operating system may be a LINUX operating system, a WINDOWS operating system, a MAC operating system, a FREEBSD operating system, a hypervisor (e.g., an ESXi, KVM or Hyper-V hypervisor) or another operating system.

The host processor 114 is a physical, or actual, processor that executes machine-readable instructions (e.g., software or firmware instructions). In examples, the host processor 114 may include one or multiple central processing unit (CPU) cores, or one or multiple graphics processing unit (GPU) cores. In addition to executing machine-readable instructions to provide an operating system, the host processor 114 may execute machine-readable instructions to provide a pre-boot environment (e.g., provide a basic input/output system (BIOS) and/or a Unified Extensible Firmware Interface (UEFI)). When an operating system is installed and the managed node 110-1 boots, the pre-boot environment may, after various tests and configurations, transition control to the operating system. This transition may include a host processor 114 executing machine-readable instructions (e.g., machine-readable instructions that are contained in a boot sector), which result in the execution of an operating system boot loader and the loading of the operating system. When an operating system is not installed and the managed node 110-1 boots from an image (e.g., an ISO image that corresponds to operating system installation media), the host processor 114 may, after various tests and configuration are performed in the pre-boot environment, execute machine-readable instructions of the image. In an example, the machine-readable instructions may be contained in a boot sector of the image. In another example, machine-readable instructions may correspond to a file of the image.

The system memory 118 includes and other memories discussed herein are non-transitory storage media that may be formed from semiconductor storage devices, memristor-based storage devices, magnetic storage devices, phase change memory devices, a combination of devices of one or more of these storage technologies, and so forth. The system memory 118 may represent a collection of memories of both volatile memory devices and non-volatile memory devices. In accordance with example implementations, the system memory 118 may store machine-executable instructions 122 and data 126. The machine-executable instructions 122 may be associated with any of a number of different software and/or firmware programs (e.g., an operating system, application programs, firmware-based preboot services, firmware-based boot services, drivers, or other programs) that are executed by the host processor(s) 114. The data 126 may include any of a number of different types of data (e.g., files, data structures, libraries, data inputs, user inputs, intermediate processing results, arrays, final processing results, kernel space data structures or data corresponding to other data types).

In the context that is used herein, a “management system” refers to a collection of one or multiple components, which provide management services for the managed node 110-1. In accordance with example implementations, the management system 130 includes a management controller, such as a baseboard management controller (BMC) 134, which provides various management services for the managed node 110-1.

In an example of a management service provided by the BMC 134, the BMC 134 may monitor a sensor (e.g., a temperature sensor, a cooling fan speed sensor, or a tamper detection sensor) that is associated with the managed node 110-1 and initiate a particular responsive action (e.g., shutting down the managed node 110-1 and/or sending an alert message to an administrative node 154) when a value sensed by the sensor deviates from an expected range or an expected value. In another example, the BMC 134 may monitor a software component (e.g., an operating system kernel or kernel data structure) of the managed node 110-1 and initiate a particular responsive action when the software component exhibits an anomalous behavior or a behavior corresponding to a security threat. In another example, the BMC 134 may monitor a power status of the managed node 110-1 and initiate a particular responsive action in response to a power status deviating from an expected state. In another example, the BMC 134 may log system events.

The BMC 134, in accordance with example implementations, provides management functions (called “remote management functions” herein) for the managed node 110-1, which may be controlled or invoked by a remote entity. In this manner, the BMC 134 may receive requests (e.g., commands) from an authorized remote entity (e.g., the remote node management system 180 or an administrative node 154) directing the BMC 134 to perform or invoke a particular remote management function. The remote management function may be one in which the BMC 134 causes the host 112 to perform a particular function. In an example, an authorized remote entity may send a request (e.g., a request sent to the BMC 134 via a RESTful interface of the BMC 134) to the BMC 134 to cause the BMC 134 to retrieve a file from a particular location (e.g., a Uniform Resource Locator (URL) address).

In another example of a remote management function, an authorized remote entity may send a request to the BMC 134 for the BMC 134 to power on the managed node 110-1. In this manner, management system 130 may receive power from a different power supply subsystem than the remaining components of the managed node 110-1. This allows the management system 130 to manage power for other components of the managed node 110-, including allowing the management system 130 to be powered up and fully functional when the managed node 110-1 is otherwise powered down. In this context used herein, the BMC 134 “powering on” the managed node 110-1 refers to the BMC 134 causing a power to be provided to the managed node 110-1 to transition components of the managed node 110-1 (other than the management system 130) from a powered-down state to a powered on-state. Powering on the managed node 110-1 may include first powering components of the managed node 110-1 (other than the management system 130). Moreover, powering on the managed node 110-1 may initiate a start up of a pre-operating system environment (e.g., an environment provided by a BIOS and/or a UEFI) of the managed node 110-1 and may result in the managed node 110-1 booting from a particular designated boot image.

In another example of a remote management function, a remote entity may send a request to the BMC 134 for the BMC 134 to cause the managed node 110-1 to mount virtual media. In this context, the “mounting” of a managed node 110-1 to virtual media refers to the virtual media becoming accessible at a particular point of a file system directory tree of the managed node 110-1. “Virtual media” generally refers to an abstraction of a physical storage device. In an example, virtual media may be an image that represents data as exactly stored on a physical drive. In an example, the virtual media may be an International Organization for Standardization (ISO) 9660 optical disk image (called an “ISO image” herein), which corresponds to the exact copy of the data that is stored on an optical disk.

In another example of a remote management function, a remote entity may send a request to the BMC 134 to cause the BMC 134 to configure the managed node 110-1 to boot to selected virtual media. In this context, a managed node 110-1 “booting” from media (e.g., an actual, physical drive or a virtual drive corresponding to virtual media) refers to the managed node 110-1 executing machine-executable instructions that are associated with the media to transition the managed node 110 from a pre-operating system environment.

The management services that are provided by the BMC 134 are part of the BMC's management plane. In accordance with example implementations, the BMC 134 may also provide security plane, which is isolated from the BMC's management plane. Using its security plane, the BMC 134 may provide various security services (e.g., secure storage for cryptographic security parameters, cryptographic services, cryptographic key sealing and unsealing, and other security services) for the managed node 110-1. In accordance with some implementations, the BMC 134 may contain a silicon root of trust engine, which corresponds to the hardware root of the chain of trust for the managed node 110-1. The silicon root of trust engine, in accordance with some implementations may, in response to the power up or reset of the managed node 110-1, measure, load and executed initial security service-related firmware for the BMC 134 to begin a measured boot of the managed node 110-1. In accordance with further implementations, the managed node 110-1 may not perform a measured boot.

As used herein, a “baseboard management controller,” or “BMC,” is a specialized service processor that monitors the physical state of a server or other hardware using sensors and communicates with a management system through a management network. The BMC may communicate with applications executing at the operating system level through an input/output controller (IOCTL) interface driver, a representational state transfer (REST) application program interface (API), or some other system software proxy that facilitates communication between the baseboard management controller and applications. The BMC may have hardware level access to hardware devices located in a server chassis including system memory. The BMC may be able to directly modify the hardware devices. The baseboard management controller may operate independently of the operating system of the managed node 110-1. The BMC may be located on the motherboard or main circuit board of the server or other device to be monitored.

The fact that a BMC is mounted on a motherboard of the managed server/hardware or otherwise connected or attached to the managed server/hardware does not prevent the BMC from being considered “separate” from the server/hardware. As used herein, a BMC has management capabilities for sub-systems of a computing device, and is separate from a processing resource that executes an operating system of a computing device. As such, the BMC 134 of the managed node 110, as an example, is separate from the host processor(s) 114, which execute the high-level operating system for the managed node 110-1.

In an example, when the operating system is installed on the managed node 110-1, the media may be virtual media, the virtual media may correspond to an image that corresponds to the installed operating system, and booting the managed node 110-1 from the virtual media may include a host processor 114 executing machine-executable instructions of the image to load and transfer control to the operating system. In an example, this process may include the host processor 114 executing instructions contained in a boot sector portion of the image. In another example, the machine-executable instructions may correspond to a file of the image. In another example, when an operating system is not installed for a managed node 110-1, booting the managed node 110-1 from particular virtual media may include the managed node 110-1 executing machine-executable instructions stored on the virtual media, which initiate a process to install an operating system on the managed node 110-1.

In another example and as further described herein, the virtual media may be an agent image 178, and booting the managed node 110 from the virtual media may include a host processor 114 of the managed node 110-1 executing machine-executable instructions of the agent image 178, which starts, or launches, an operating installation assistance agent 106 (called the “agent 106” herein) that assists in installing an operating system on the managed node 110-1. This assistance, as further described herein, includes the agent 106 generating an answer file that provides one or multiple configuration options for the operating system.

As depicted in FIG. 1, in accordance with example implementations, in addition to the BMC 134, the management system 130 may include a secure repository 138. In an example, the secure repository 138 may be formed from non-volatile memory devices (e.g., flash memory devices) that are mounted to a motherboard of a computer platform that is associated with the managed node 110. In an example, the secure repository 138 may include NAND flash memory devices and correspondingly be referred to as a “NAND repository” of the managed node 110-1. In an example, in accordance with some implementations, the BMC 134 may control access to the secure repository 138. In an example, the BMC 134 may limit access to the secure repository 138 to certain authorized entities (e.g., the BMC 134, a software update manager (SUM), a basic input/output system (BIOS) and a Unified Extensible Firmware Interface (UEFI)) of the managed node 110. In an example, the BMC 134 may access the secure repository 138 on behalf of an authorized entity to retrieve or store data stored in the secure repository 138, and the BMC 134 may communicate the data with the authorized entity using in-band communication. In an example, the secure repository 138 may store data that represents signed images, such as data that represents a signed firmware update package.

In another example and as further described herein, the secure repository 138 may store configuration option data 139 that represents one or multiple selected operating system configuration options that are specific to the installation of an operating system on the managed node 110-1 and which customize the operating system for the specific managed node 110-1. In examples, the configuration options may include one or multiple of the following: an IP address of the managed node 110-1, a user name, user credentials, an operating system license key, a display language, an administrator name, administrator credentials, a time zone, partition designations, or other information to customize the operating system for the managed node 110-1.

In accordance with example implementations, the agent 106 includes an answer file generator 107 to generate an answer file to, based on the configuration option data 139, generate an answer file that corresponds to an operating system installation image. More specifically, in accordance with example implementations, an executable file of the operating system installation media searches for a specific answer file (e.g., a particular XML file) that contains data representing configuration option selections for customizing the operating system. The operating system installation media for different operating systems may have different criteria for the answer file, such as different file names and answer file locations and different semantics and syntaxes for the answer file content. In an example, WINDOWS operating system installation media may expect an answer file that designates configuration options in a certain way for different configuration passes in the installation process. In an example, WINDOWS operating system installation media may expect an answer file in an XML format. Other operating system installation media associated with other operating systems (e.g., LINUX) may expect answer files in other formats, such as a Yet Another Markup Language (YAML) format or a JAVASCRIPT Object Notation (JSON) format. In an example, the answer file generator 107 stores the answer file in a location (e.g., a particular subdirectory) at which an executable file of the operating system installation media expects to find the answer file. In an example, the answer file generator 107 stores the answer file in a storage device (e.g., a hard disk) of the host 112. In an example, the answer file generator 107 stores the answer file in a partition of the storage device; the agent 106 copies files of the operating system installation media into the same partition; and the agent 106 starts the installation of the operating system from the partition.

The remote node management system 180, in accordance with example implementations, provides one or multiple remote node management services for the managed nodes 110. In an example, the managed nodes 110 depicted in FIG. 1 may correspond to a fleet of nodes of a particular subscribing customer or a particular, designated group of nodes for the customer. For the example implementations that are described herein, the remote node management service 181 is an operating system installation service. The remote node management system 180 may, however, provide one or multiple services other than operating system installation services. In an example, the node management system 180 may monitor compliance of the managed nodes 110 with a particular policy and initiate one or multiple actions in response to noncompliance. For example, a policy may specify that an IT administrator 150 is to be notified when firmware upgrades or updates are available for managed nodes 110 of the group. The IT administrator 150 may, via an administrative node 154, schedule when firmware updates are to be performed, and for each managed node 110 upon which the firmware update is to be performed, the node management system 180 may use the remote control functionality of the managed node's BMC 134 to upgrade the node's firmware.

In accordance with example implementations, the node management system 180 may include one or multiple management nodes 182. In general, a management node 182 is a processor-based entity that has an associated set of hardware and software resources. In an example, the management node 182 may be a physical computer platform. In another example, the management node 182 may correspond to a smart I/O peripheral. In another example, the management node 182 may be a virtual node (e.g., a virtual machine). Regardless of its particular form, in accordance with example implementations, a management node 182 is associated with one or multiple processors 184 and a system memory 186. In accordance with example implementations, the system memory 186 may store machine-executable instructions 188 and data 190. The machine-executable instructions 188 may provide processes to provide one or multiple cloud-based node management services, such as the remote node management service 181. In an example, the data 190 may include operating system installation configuration options for one or multiple managed nodes 110. In an example, the data 190 may include preliminary, immediate or final data associated with node management services, such as the remote node management service 181, which are provided by the remote node management system 180. Regardless of the particular architecture or form of the management node(s) 182, the management node(s) correspond to one or multiple physical machines that execute machine-readable instructions to provide one or multiple node management services.

An IT administrator 150, in accordance with example implementations, may provide inputs (e.g., inputs provided by file uploads, keystrokes, touch gestures, mouse movements, graphical user interface (GUI) selections and/or other input mechanisms) to the remote node management system 180 for purposes of setting up parameters to guide and regulate the installation of operating systems on the managed nodes 110. For this purpose, the IT administrator 150 may, for example, interact with a GUI 155 (e.g., a dashboard) that is provided by the remote node management system 180. In this manner, the GUI 155 allows the IT administrator 150 to view output (e.g., nodes statuses, management states, profiles, previously-entered input, and other information) that is provided by the remote node management system 180 and provide input (e.g., profiles, operating system installation configuration options and other parameters to control remote node management service) to the remote node management system 180. In an example, the IT administrator 150 may access the GUI 155 via an Internet browser or other software that executes on an administrative node 154.

In an example, an IT administrator 150 may provide, as input to the remote node management system 180 (via, for example the GUI 155), selections of operating system installation configuration options for one or multiple new managed nodes 110 for which operating systems are to be installed. In another example, an IT administrator 150 may provide, as input to the remote node management system 180, a trigger to initiate the installation of an operating system on a managed node 110 that has been added to the fleet or is replacing another managed node 110. In another example, an IT administrator 150 may provide, as input to the remote node management system 180, a trigger to initiate the installation of operating systems on a particular group of new managed nodes 110 that are being added to the fleet.

Although some operating system installation configuration options may be provided by an IT administrator 150, the remote node management system 181 may derive other operating system installation configuration options. In an example, the remote node management service 181 may derive specific configuration options for a new managed node 110 from the configuration options that were applied to a managed node 110 that the new managed node 110 is replacing. In another example, the remote node management service 181 may apply one or multiple policies (e.g., policies to determine a display language and/or a time zone based on a geographical region served by the managed node 110) to derive configuration options. In another example, the remote node management service 181 may derive some configuration options for a particular new node based on a group membership of the node. In an example, a particular group of managed nodes may have the same administrator name and administrative credentials.

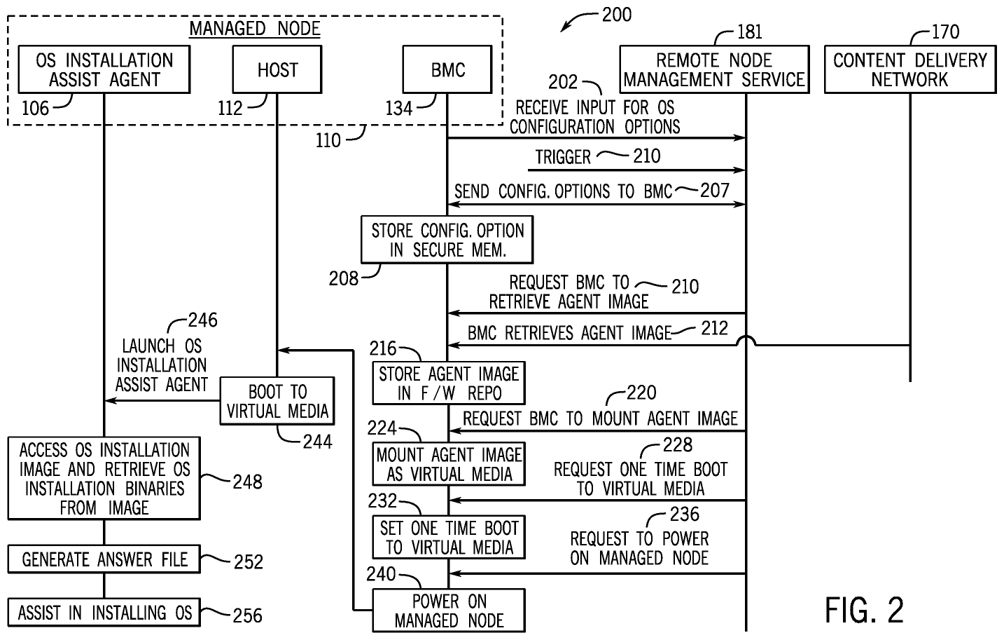

As further described further herein in connection with FIG. 2, for purposes of installing an operating system on the managed node 110-1, the remote node management service 181 uses remote management functions of the BMC 134. In an example, the remote node management service 181 sends the BMC 134 the operating system installation configuration options and instructs the BMC 134 to store the configuration options in the secure repository 138 (as the configuration option data 139).

In other examples of the use of remote management functions by the remote node management service 181, the service 181 may instruct the BMC 134 to retrieve a relatively small (e.g., on the order of a few hundred Megabytes (MB) or smaller in size) operating system assistance agent image 178 (called an “agent image 178” herein), cause the managed node 110-1 to mount the agent image 178 as virtual media and cause the managed node 110-1 to power on to boot to the mounted agent image 178. In an example, as depicted by path 194, the agent image 178 may be retrieved by the BMC 134 from a remote content delivery network 170 (as depicted by path 194). In an example, the content delivery network 170 may store multiple agent images 178 that correspond to different operating systems, and the remote node management service 181 may provide a URL address for the agent image 178 that corresponds to the specific operating system that is being installed on the managed node 110-1.

In accordance with example implementations, the agent image 178 contains machine-readable instructions that correspond to the agent 106 such that execution of the machine-readable instructions by one or multiple host processors 114 of the managed node 110-1 form an instance of the agent 106. In an example, the agent image 178 may contain boot sector-affiliated machine-readable instructions that initiate execution of the machine-readable instructions that form the instance of the agent 106. In an example, the agent image 178 may be an ISO image that contains a boot sector having machine-readable instructions that are executed by a designated boot host processor 114 and whose execution initiates execution of one or multiple executable files that correspond to the agent 106. In another example, the agent image 178 may be an ISO image, and a designated boot host processor 114 may, upon boot of the managed node 110-1, read and execute a particular executable file that corresponds to the agent 106 without executing boot sector instructions. Regardless of the particular mechanism that is used, the booting of the managed node 110-1 from the agent image 178 begins, or launches, an instance of the agent 106.

The agent 106, in accordance with example implementations, performs actions to prepare the managed node 110-1 for the installation of the operating system. In an example, the assist agent 106 may access an operating system installation image 146 (also referred to as an “operating system installation media” herein) from a repository 144. In an example, the operating system installation image 146 may be an ISO image. In general, the operating system installation image 146 may contain content for installing a particular operating system including executable files corresponding to operating system installation and files corresponding to the operating system (e.g., files corresponding to an operating system kernel, an operating system bootloader and other files).

In accordance with example implementations, the operating system installation image 146 does not include an answer file that contains specific operating system configuration options for the managed node 110-1, and the same operating system installation image 146 is used to install operating systems on multiple managed nodes 110. The specific operation system configuration options for each installation are provided by an answer file that is generated by an agent 106 of the managed node 110 on which the operating system is being installed.

Because the operating system installation image 146 may be relatively large (e.g., a size on the order of multiple Gigabytes (GB)), in accordance with example implementations, the operating system installation image 146 may be stored locally in a local repository 144, as represented by a local connection 140 between the repository 144 and the managed nodes 110 in FIG. 1. In examples, the local repository 144 may correspond to one or multiple storage devices (e.g., a direct attached storage device, a storage corresponding to persistent memory devices of the managed node 110, a network attached storage or one or multiple other storage devices) that are located in the same local network as the managed nodes 110.

In accordance with example implementations, the agent 106 accesses the local repository 144 and retrieves files from an operating system installation image 146. In an example, the agent 106 may store the retrieved files in a specific partition of a storage device (e.g., a hard disk) of the managed node 110-1. In an example, one of the retrieved files may be an executable file (e.g., a setup executable file) that initiates the operating system installation process.

Before the operating installation process is initiated, the answer file generator 107 of the agent 106 generates an answer file that contains one or multiple options for configuring the operating system. In accordance with example implementations, the agent 160 generates the answer file based on the configuration option data 139 that stored locally on the managed node 110-1. In an example, the answer file generator 107 generates the answer file such that a syntax and semantic of the content of the answer file corresponds to the syntax and semantics expected by the executables of the operating system installation image 146. In an example, the answer file generator 107 generates a filename for the answer file to correspond to the filename expected by the executables of the operating system installation image 146. In an example, the answer file generator 107 stores the answer file in a location (e.g., in a particular subdirectory or in a partition in which the transferred files from the operating system installation image 146 are located) that corresponds to the location expected by the executables of the operating system installation image 146.

Among the other features of the computer system 100, in accordance with some implementations, the managed nodes 110, the node management system 180, the content delivery network 170 and the administrative node(s) 154 may be communicatively coupled together via network fabric 160. The network fabric 160 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

FIG. 2 depicts an example flow sequence 200 used by a remote node management service 181 to install an operating system on a managed node 110 according to an example implementation. Referring to FIG. 2, the flow sequence 200 includes the node management service 181 receiving input that represents selected operating system configuration options, as depicted at 202. In an example, an IT administrator may, through a GUI that is provided by the node management service 181, select one or multiple configuration options for the managed node 110.

In an example, in accordance with some implementations, a set of selected configuration options may be shared in common with managed nodes of a particular, designated group of nodes. For example, in accordance with some implementations, a group of managed nodes may share access to the same repository in which operating system installation images are stored. In another example, a group of nodes may be associated with the same time zone. Some configuration options may be specific to a particular managed node, even though the managed nodes are part of the same group. In an example, each of the managed nodes may have a different IP address. In another example, each of the managed nodes may have a different operating system license key. Moreover, in another example, different managed nodes of the same group may have different operating systems.

As depicted at 207, the remote node management service 181 may send the selected configuration options for the managed node 110 to the node 110. Moreover, as depicted at 208, a BMC 134 of the managed node 110 may store the configuration options in a secure memory of the BMC 134. Depending on the particular implementation, the sending of the configuration options and the storing of the configuration options on the managed node 110 may occur in a number of different ways. In an example, the node management service 181 may send a message to the BMC 134 of the managed node 110 for purposes of communicating the configuration options to the BMC 134, and the BMC 134 may then store data representing the configuration options in the secure repository (e.g., the secure repository 138 of FIG. 1) of the managed node 110.

In another example, the node management service 181 may send a request to the BMC 134 of the managed node 110 for the BMC 134 to retrieve the configuration options for the managed node 110. In this manner, the BMC 134 may be configured with a particular address or location, such as a URL address, from which to retrieve a file containing the configuration options.

For the particular example implementation that is depicted in FIG. 2, the sending of the selected configuration options and the storage of the configuration options occur after a trigger 203 initiates installation of the operating system on the managed node 110. In accordance with further implementations, the configuration options may be stored on the managed node 110 after the triggering of the operating system installation.

In an example, the trigger 203 may be initiated an IT administrator from the remote node management service 181 (e.g., an IT administrator may initiate the operating system installation via interaction with a dashboard or GUI provided by the service 181). In another example, the trigger 203 may occur responsive to a policy that specifies that an operating system is to be installed on any new managed node that is added to a particular group that is covered by the policy.

In response to the trigger 203, the remote node management service 181 first provides, as depicted at 210, a request to the BMC 134 for the BMC 134 to retrieve an agent image. In response to the request, the BMC 134 retrieves the agent image from the content delivery network 170, as depicted at 212. In an example, in accordance with some implementations, the BMC 134 may be configured with a URL address of the agent image. The BMC 134 stores the agent image in a secure repository of the managed node 110, as depicted at 216.

The flow sequence 200 next includes the remote node management service 181 requesting the BMC 134 to mount the agent image as virtual media, as depicted at 220. In response to the request, the BMC 134 then mounts the agent image as virtual media, as depicted at 224. The remote node management service 181 then prepares the managed node 110 to boot one time from the mounted virtual media. This preparation includes, as depicted at 228, the node management service 181 requesting a one time boot of the managed node to the virtual media. In response to the request, the BMC 134 configures the host 112 to boot from the virtual media, as depicted at 232. Next, as depicted at 236, the node management service 181 requests the BMC 134 to power on the managed node 110. This may include the BMC 134 performing a power on reset of the managed node 110, if the managed node 110 is otherwise fully powered up. As depicted at 240, the BMC 134 then powers on the managed node 110.

The powering on of the managed node 110 causes the managed node 110 to boot to the virtual media (and therefore, boot to the agent image), as depicted at 244. This booting to the virtual media, in turn, launches the agent 106, as depicted at 246.

After being launched, the agent 160 accesses (block 248) the operating system installation image to retrieve files (e.g., executable files) from the installation image and store the images locally on the managed node 110. Additionally, the agent 106 generates an answer file based on the selected configuration options that are stored on the managed node 110, as depicted at 252. In an example, to generate the answer file, the agent 106 may retrieve the selected configuration options via in-band communication with the BMC 134. The agent 106 may then perform additional assistance in installing the operating system, as depicted at 256. In an example, this assistance may include installing a software update manager (SUM) on the managed node 110. In an example, the SUM may, for example, manage the initiation and installation of software upgrade packages on the managed node 110 including, for example, managing firmware upgrades for the managed node 110. In an example, the assistance by the agent 106 may include the agent 106 initiating execution of a specific executable file (e.g., a setup executable file) of the operating system installation image to begin the unattended installation process.

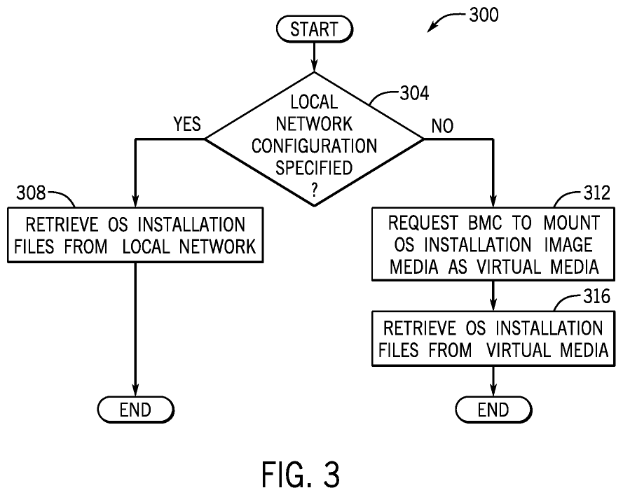

FIG. 3 depicts a process 300 used by an operating system installation assistance agent (e.g., the agent 106 of FIGS. 1 and 2) for purposes of accessing an operating system installation image and retrieving one or multiple files of the image. Referring to FIG. 3, in accordance with example implementations, the process 300 includes the agent determining (decision block 304) whether a local network configuration has been specified for the managed node. In accordance with some implementations, the local network configuration may be set up by a remote node management service. For example, parameters for a local network configuration may be provided, as inputs, by an IT administrator to the remote management service and communicated by the remote management node service to the managed node 110. The local network configuration may, for example, specify a particular subnet in which a repository for the operating system installation image is contained.

If, pursuant to decision block 304, a local network configuration has been specified for the managed node 110, then the agent retrieves the operating system installation files from the local network of the managed node, pursuant to block 308. If, however, pursuant to decision block 304, a local network configuration has not been specified for the managed node, then the agent requests the BMC of the managed node to mount operating system installation media as virtual media, pursuant to block 312. In an example, the BMC 134 may have previously retrieved the operating system installation image, and the BMC 134 may have stored the operating system installation image in a memory (e.g., a secure repository) of the managed node. After mounting the operating system installation image as virtual media, the process 300 includes the BMC retrieving operating system installation files from the mounted virtual media, as depicted at block 316.

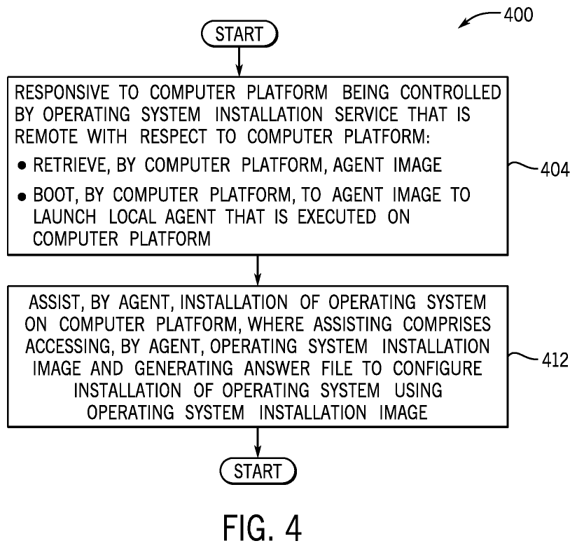

Referring to FIG. 4, in accordance with example implementations, a process 400 includes, pursuant to block 404, responsive to a computer platform being controlled by an operating system installation service that is remote with respect to the computer platform, retrieving, by the computer platform, an agent image, and booting, by the computer platform, to the agent image to launch a local agent that is executed on the computer platform. In accordance with example implementations, the computer platform may be a server. In an example, the computer platform may provide a managed node upon which an operating system is to be installed using the assistance of the agent image. In accordance with example implementations, the remote content provider may be associated with a content delivery network. In accordance with example implementations, the agent image may be an ISO image.

In an example, retrieving the agent image may include requesting a baseboard management controller of the computer platform to retrieve the agent image. In an example, retrieving the agent image may include a baseboard management controller of the computer platform retrieving the agent image from a particular location (e.g., a location represented by a URL address).

In an example, a management controller, such as a baseboard management controller, of the computer platform may configure the computer platform to boot to the agent image. In an example, booting the computer platform to the agent image includes requesting the baseboard management controller to mount the agent image as virtual media. In an example, booting the computer platform to the agent image includes requesting the baseboard management controller of the computer platform to power on the computer platform. The request for power on may be a request for the computer platform to power on one time to the agent image.

As depicted in block 412, the process 400 includes assisting, by the local agent, an installation of an operating system on the computer platform. In an example, the assistance by the local agent includes a host of the computer platform executing machine-readable instructions that correspond to the agent. The assisting includes accessing, by the local agent, an operating system installation image. In an example, accessing the operating system installation image includes the local agent accessing files of the operating system image, which are stored in a local network associated with the computer platform. In an example, accessing the operating system installation image includes the local agent causing a baseboard management controller of the computer platform to mount an operating system installation image as virtual media. In an example, accessing the operating system installation image includes the host of the computer platform retrieving files of the operating system installation image.

The assistance by the local agent includes accessing, by the local agent, an operating system installation image and generating an answer file to configure installation of the operating system using the operating system installation image. In an example, the configuration option may be a time zone associated with the computer platform. In an example, the configuration option may be an IP address of the computer platform. In an example, the configuration option may be a storage partition associated with the computer platform. In an example, the configuration option may be a user name or an IT administrator name for the computer platform. In an example, the configuration option may be an access credential. In an example, the configuration option may be a display language. In an example, the configuration option may be a license key.

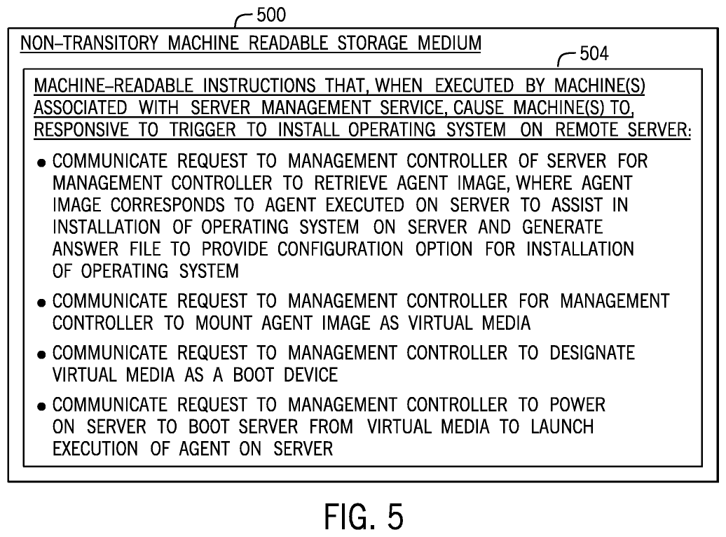

Referring to FIG. 5, in accordance with an example implementation, a non-transitory machine-readable storage medium 500 stores machine-readable instructions 504. The instructions 504, when executed by one or multiple machines associated with a management service, cause the machine(s) to, responsive to a trigger to install an operating system on a remote server, communicate a request to a management controller of the server for the management controller to retrieve an agent image. The agent image corresponds to an installation agent that has been executed on the server to assist in the installation of the operating system on the server and generate an answer file to provide a configuration option for the installation of the operating system. In an example, the management controller may be a baseboard management controller. The communication of the request may include communicating a request to initiate a remote management function of the management controller. In an example, the request causes the management controller to retrieve the agent image from a content delivery network. In an example, the request causes the management controller to retrieve the agent image from a predefined location (e.g., a predefined URL address). In an example, the request may cause the management controller to store the retrieved agent image in a secure repository of the server.

In an example, the configuration option may be a time zone associated with the server. In an example, the configuration option may be an access credential for the server. In an example, the configuration option may be an IP address of the server. In an example, the configuration option may be a user name or IT administrator name associated with the server. In an example, the configuration option may be a partition configuration. In an example, the configuration option may be a license key. In an example, the configuration option may be a display language. In an example, the answer file may be associated with an operating system installation image. In an example, the answer file may be an extended Markup Language (XML) file. In an example, the agent image may be an ISO image. In an example, data representing the configuration option may be stored locally on the server. In an example, data representing the configuration option may be stored in a secure repository managed by the management controller. In an example, the management controller may be a baseboard management controller.

The instructions 504, when executed by the machine(s), cause the machine(s) to, responsive to the trigger, communicate a request to the management controller for the management controller to mount the agent image as virtual media. In an example, the instructions 504 may configure the server to boot from the virtual media. In an example, communicating the request may include invoking a remotely-controlled management function of the management controller.

The instructions 504, when executed by the machine(s), further cause the machine(s) to, responsive to the trigger, communicate a request to the management controller to configure the server to boot from the virtual media; and communicate a request to the management controller to power on the server to boot the server from the virtual media to launch execution of the agent on the server. In an example, the request to cause the management controller to configure the server to boot from the virtual media may include a request to invoke a remotely-controlled management function of the management controller. In an example, the request to power on the server may include a request to power on the server one time, booting from the virtual media. In an example, launching execution of the agent on the server includes a host processor of the server executing machine-readable instructions that correspond to the agent.

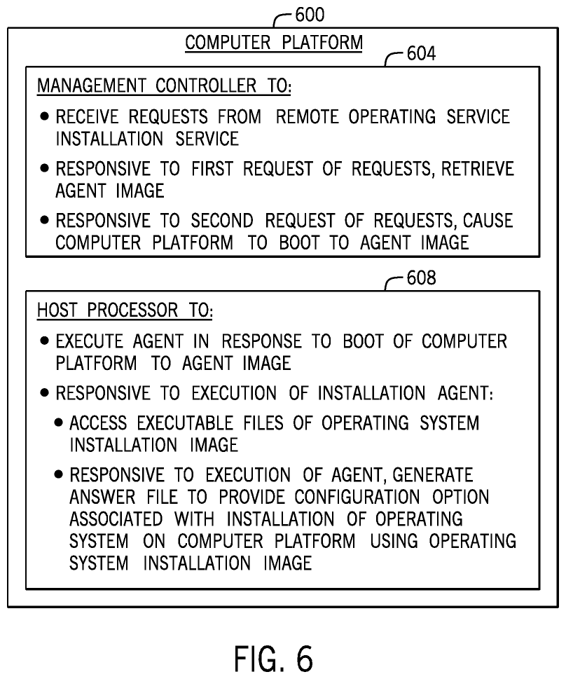

Referring to FIG. 6, in accordance with example implementations, a computer platform 600 includes a management controller 604 and a host processor 608. In an example, the management controller may be a baseboard management controller. In an example, the host processor 608 may include one or multiple central processing unit (CPU) cores or one or multiple graphics processing unit (GPU) cores.

The management controller 604 receives requests from a remote operating system installation service. The management controller 604, responsive to a first request of the requests, retrieves an agent image. In an example, the first request may invoke a remotely-controlled management function of the management controller. In an example, retrieving the agent image may include the management controller retrieving the agent image from a remote content delivery network. In an example, the agent image may be an ISO image. In an example, the management controller may retrieve the agent image from a designated URL address. In an example, the remote operating system installation service may provide the URL address.

The management controller 604, responsive to a second request of the requests, causes the computer platform 600 to boot to the agent image. In an example, causing the computer platform to boot to the agent image includes causing the computer platform to boot to virtual media. In an example, the remote management service may request the management controller to mount the agent image as virtual media.

The host processor 608 executes an agent in response to the boot to the agent image. In an example, booting to the agent image launches the execution of the installation agent. In an example, executing the agent includes the host processor executing machine-readable instructions of the agent image. The host processor 608, responsive to the execution of the agent, accesses executable files of an operating system installation image. In an example, accessing the executable files of the operating system installation image includes the host processor 608 accessing the operating system installation image from a local network associated with the computer platform 600. In an example, accessing the executable files includes the management controller mounting the operating system installation image as virtual media, and the host processor accessing the virtual media to access the executable files.

The host processor 608 executes the agent in responsive to the boot of the computer platform to the agent image. The host processor 608, responsive to the execution of the agent, generates an answer file to provide a configuration option that is associated with an installation of an operating system on the computer platform using an operating system installation image. In an example, the host processor 608 may generate the answer file responsive to locally-stored data that represents one or multiple configuration options selected by an IT administrator and communicated to the computer platform by the remote management service. In an example, a configuration option may be a time zone associated with the computer platform 600. In an example, a configuration option may be an IP address of the computer platform. In an example, a configuration option may be a user name or an IT administrator name associated with the computer platform 600. In an example, a configuration option may be a partition configuration for the computer platform 600. In an example, a configuration option may be a license key. In an example, a configuration option may be a display language. In an example, a configuration option may be an access credential.

In accordance with example implementations, the computer platform includes a baseboard management controller, and the process further includes receiving, by the baseboard management controller, commands from a remote management service. The process includes responding, by the baseboard management controller, to the commands, to receive the agent image from the remote content provider and cause the computer platform to boot to the agent image. A particular advantage is that operating system installation image may be used to install an operating system without burdening an IT administrator with creating an answer file.

In accordance with example implementations, responding to the commands to retrieve the agent image includes storing, by the baseboard management controller, the agent image in a secure repository of the computer platform. A particular advantage is that an operating system installation image may be used to install an operating system without burdening an IT administrator with creating an answer file.

In accordance with example implementations, responding to the commands includes mounting, by the baseboard management controller, the agent image as virtual media. A particular advantage is that an operating system installation image may be used to install an operating system without burdening an IT administrator with creating an answer file.

In accordance with example implementations, responding to the commands includes designating, by the baseboard management controller, the virtual media as a boot drive device. A particular advantage is that an operating system installation image may be used to install an operating system without burdening an IT administrator with creating an answer file.

In accordance with example implementations, responding to the commands includes powering on, by the baseboard management controller, the computer platform. A particular advantage is that an operating system installation image may be used to install an operating system without burdening an IT administrator with creating an answer file.

In accordance with example implementations, the accessing includes responsive to a local network configuration being set up for the computer platform, retrieving, by the agent, executable files of the operating system installation image from a local network associated with the computer platform. A particular advantage is that an operating system installation image may be used to install an operating system without burdening an IT administrator with creating an answer file.

In accordance with example implementations, the computer platform includes a baseboard management controller. The accessing includes responsive to a local network configuration not being set up for the computer platform, sending, by the agent, a request to the baseboard management controller, for the baseboard management controller to mount the operating system installation image as virtual media; responsive to the request, mounting, by the baseboard management controller, the operating system installation image as the virtual media; and accessing, by the agent, the virtual media to retrieve executable files of the operating system installation image. A particular advantage is that an operating system installation image may be used to install an operating system without burdening an IT administrator with creating an answer file.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “connected,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
responsive to a computer platform being controlled by an operating system installation service that is remote with respect to the computer platform:
retrieving, by the computer platform, an agent image; and
booting, by the computer platform, to the agent image to launch a local agent that is executed on the computer platform; and
assisting, by the local agent, an installation of an operating system on the computer platform, wherein the assisting comprises accessing, by the local agent, an operating system installation image and generating an answer file to configure installation of the operating system using the operating system installation image.

2. The method of claim 1, wherein the computer platform comprises a baseboard management controller, the method further comprising:
receiving, by the baseboard management controller, commands from the operating system installation service; and
responding, by the baseboard management controller, to the commands to retrieve the agent image from a remote content provider and cause the computer platform to boot to the agent image.

3. The method of claim 2, wherein the responding comprises storing, by the baseboard management controller, the agent image in a secure repository of the computer platform.

4. The method of claim 2, wherein the responding comprises mounting, by the baseboard management controller, the agent image as virtual media.

5. The method of claim 4, wherein the responding further comprises designating, by the baseboard management controller, the computer platform to boot from the virtual media one time.

6. The method of claim 2, wherein the responding comprises powering on, by the baseboard management controller, the computer platform.

7. The method of claim 1, wherein accessing the operating system installation image comprises:
responsive to a local network configuration being set up for the computer platform, retrieving, by the local agent, executable files of the operating system installation image from a local network associated with the computer platform.

8. The method of claim 1, wherein:
the computer platform comprises a baseboard management controller; and
the accessing comprises responsive to a local network configuration not being set up for the computer platform:
sending, by the agent, a request to the baseboard management controller, for the baseboard management controller to mount the operating system installation image as virtual media;
responsive to the request, mounting, by the baseboard management controller, the operating system installation image as virtual media; and
accessing, by the local agent, the virtual media to retrieve executable files of the operating system installation image.

9. A non-transitory machine-readable storage medium that stores machine-readable instructions that, when executed by at least one machine associated with a management service, cause the at least one machine to, responsive to a trigger to install an operating system on a remote server:
communicate a request to a management controller of the server for management controller to retrieve an agent image, wherein the agent image corresponds to an agent executed on the server to assist in the installation of the operating system on the server and generate an answer file to provide a configuration option for the installation of the operating system;
communicate a request to the management controller for the management controller to mount the agent image as virtual media;
communicate a request to the management controller to configure the server to boot from the virtual media; and
communicate a request to the management controller to power on the server to boot the server from the virtual media to launch execution of the agent on the server.

10. The storage medium of claim 9, wherein the instructions, when executed by the at least one machine, further cause the at least one machine to:
communicate with the management controller to cause the management controller to store data on the server representing the configuration option.

11. The storage medium of claim 9, wherein the instructions, when executed by the at least one machine, further cause the at least one machine to:
receive input representing a network configuration for the server; and
communicate with the management controller to cause the management controller to store data on the server representing the network configuration, wherein the agent uses the network configuration to access an operating system installation image.

12. The storage medium of claim 9, wherein the instructions, when executed by the at least one machine, further cause the at least one machine to:
provide, to the management controller, an address to retrieve the agent image.

13. The storage medium of claim 9, wherein:
the server is added to a server group;
the server group is associated with a policy; and
the instructions, when executed by the at least one machine, further cause the at least one machine to, responsive to determining that the policy contains a rule to initiate installation of the operating system on the server due to the server being added to the group, generate the trigger.

14. The storage medium of claim 9, wherein the instructions, when executed by the at least one machine, further cause the at least one machine to receive the trigger responsive to user input.

15. A computer platform comprising:
a management controller to:
receive requests from a remote operating system installation service;
responsive to a first request of the requests, retrieve an agent image; and
responsive to a second request of the requests, cause the computer platform to boot to the agent image; and
a host processor to:
execute an agent in response to the boot of the computer platform to the agent image; and
responsive to the execution of the agent, generate an answer file to provide a configuration option associated with an installation of an operating system on the computer platform using an operating system installation image.

16. The computer platform of claim 15, further comprising:
a memory corresponding to a secure repository,
wherein the management controller to further store the agent image in the secure repository responsive to the management controller retrieving the agent image.

17. The computer platform of claim 15, wherein the management controller to further:
in response to a third request of the requests, mount the agent image as virtual media; and
in response to a fourth request of the requests, set up the computer platform to boot from the virtual media.

18. The computer platform of claim 17, wherein the management controller to further, in response to a fourth request of the requests, power on the computer platform to cause the computer platform to boot from the virtual media.

19. The computer platform of claim 15, wherein the host processor to further execute the agent to install a firmware update manager.

20. The computer platform of claim 15, wherein the management controller comprises a baseboard management controller.
